(19) United States
(12) Patent Application Publication
(10) Pub. No.: US 2020/0218919 A1
(43) Pub. Date: Jul. 9, 2020

(54) VOLUMETRIC IMAGING THROUGH A FIXED PATTERN APERTURE

(71) Applicant: Nokia Technologies Oy, Espoo (FI)

(72) Inventors: Jong-Hoon AHN, Randolph, NJ (US); Gang HUANG, Monroe Township, NJ (US); Hong JIANG, Warren, NJ (US)

(21) Appl. No.: 16/737,014

(22) Filed: Jan. 8, 2020

Related U.S. Application Data
(60) Provisional application No. 62/789,922, filed on Jan. 8, 2019.

(51) Int. Cl. G06K 9/20; G01B 11/25; G06T 17/00; G06T 7/593; G06K 9/00

(52) U.S. Cl. CPC G06K 9/209; G01B 11/2513; G06T 17/00; G06T 2200/04; G06K 9/00201; G06T 2207/10028; G06T 7/593

(57) ABSTRACT

A camera includes a fixed pattern aperture with a pattern that has a transmittance that is different in different portions of the fixed pattern aperture. The camera also includes an array of sensors that generate signals based on an intensity of light received by the sensors through the fixed pattern aperture. In some cases, the camera includes a processor to generate measurement vectors based on values of signals received from the sensors in the sensor array when exposed to a scene. The processor is also configured to determine values of voxels that represent a 3D image of the scene based on the measurement vectors. A transformed sensing matrix associated with the fixed pattern aperture and the sensor array is generated based on measurement vectors captured by the camera when exposed to basis images at different separations from the camera. Volumetric images of objects are determined from the transformed sensing matrix.

### BACKGROUND

Three-dimensional (3D) volumetric imaging is used to capture an image of an object or a scene in three physical dimensions. The 3D image is represented as a collection of discrete, non-overlapping volume elements that are referred to as voxels, which are analogous to two-dimensional (2D) pixels that represent 2D images of an object or a scene. Values of the voxels represent light intensities in one or more frequency bands or colors. A conventional 3D imaging device captures multiple 2D images using multiple cameras that are displaced from each other, e.g., stereoscopic cameras. Each camera captures a different projection of the 3D object onto a 2D plane and the 2D images captured by the cameras are used to estimate depth information for the 3D object. The cameras that capture the 2D images of the 3D object include lenses to focus the received light onto imaging planes in the cameras. A light field (or plenoptic) camera captures light intensity and directions of light rays emanating from an object or scene, which can be used to generate volumetric information. However, a light field camera typically uses a lens system including a primary lens and an array of micro lenses. Generating 3D volumetric images of an object or scene using multiple cameras and/or multiple lens systems is inconvenient and costly at least in part due to the cost of the lenses.

### SUMMARY

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, an apparatus includes a fixed pattern aperture having a three-dimensional (3D) pattern of transmittance. The transmittance is different in different portions of the fixed pattern aperture. The apparatus also includes a sensor array comprising a plurality of sensors that generate signals based on an intensity of light received by the sensors through the fixed pattern aperture.

In some embodiments, the 3D pattern of transmittance is unknown.

In some embodiments, the 3D pattern of transmittance is determined by a randomly selected pattern, an orderly selected pattern, or a naturally occurring pattern.

In some embodiments, the fixed pattern aperture includes a structured pinhole aperture.

Some embodiments of the apparatus include a processor configured to generate measurement vectors based on the signals generated by the sensors in the sensor array when exposed to a scene and determine values of voxels that represent a 3D image of the scene based on the measurement vectors.

Some embodiments of the processor are configured generate the values of the voxels that represent the 3D image of an arbitrary object by forming a linear combination of a plurality of basis images associated with a plurality of layers positioned at different distances from the fixed pattern aperture.

In some embodiments, the sensor array is configured to capture a measurement vector of intensities of light from the arbitrary object that passes through the fixed pattern aperture.

In some embodiments, the processor is configured to generate a vector of coefficients that represent weights of the basis images based on an inverse of a transformed sensing matrix associated with the fixed pattern aperture or sparsity maximization of a voxel image.

In some embodiments, the processor is configured to recover a 3D image that represents the arbitrary object based on the vector of coefficients that represent the weights of the basis images.

In some embodiments, the processor is configured to generate the transformed sensing matrix based on a plurality of measurement vectors of basis images in the plurality of layers positioned at different distances from the fixed pattern aperture.

In some embodiments, the sensor array is configured to capture the plurality of measurement vectors by capturing images of a plurality of basis images in each of the plurality of layers.

In some embodiments, separations between the plurality of layers are constant or increasing with distance from the fixed pattern aperture.

In some embodiments, the processor is configured to form a plurality of columns of the transformed sensing matrix with the plurality of measurement vectors associated with the plurality of basis images at the different distances.

In some embodiments, an apparatus includes a memory configured to store information representative of signals generated by sensors in a sensor array based on an intensity of light received by the sensors through a fixed pattern aperture having a pattern of transmittance. The transmittance is different in different portions of the fixed pattern aperture. The apparatus also includes a processor configured to generate measurement vectors based on values of signals received from the sensors in the sensor array when exposed to a scene and determine values of voxels that represent a three-dimensional (3D) image of the scene based on the measurement vectors.

In some embodiments, the pattern of transmittance is unknown.

In some embodiments, the processor is configured generate the values of the voxels that represent the 3D image of the scene by forming a linear combination of a plurality of basis images associated with a plurality of layers positioned at different distances from the fixed pattern aperture.

In some embodiments, the sensor array is configured to capture a measurement vector of intensities of light that passes through the fixed pattern aperture and the processor is configured to generate a vector of coefficients that represent weights of the basis images based on the measurement vector and an inverse of a transformed sensing matrix associated with the fixed pattern aperture or sparsity maximization of a voxel image.

In some embodiments, the transformed sensing matrix is formed based on a plurality of measurement vectors of basis images in the plurality of layers positioned at different distances from the fixed pattern aperture.

In some embodiments the processor is configured to recover a 3D image that represents the scene based on the vector of coefficients that represent the weights of the basis images.

Embodiments of a method include receiving, using a sensor array that includes a plurality of sensors, light from a plurality of layers through a fixed pattern aperture having a three-dimensional (3D) pattern of transmittance that is different in different portions of the fixed pattern aperture. The layers are positioned at different distances from the fixed pattern aperture. The method also includes generating a plurality of measurement vectors of basis images based on the light received from the plurality of layers through the fixed pattern aperture. The method further includes generating a transformed sensing matrix associated with the fixed pattern aperture and the sensor array based on the plurality of measurement vectors.

In some embodiments, capturing the plurality of measurement vectors includes capturing images of a plurality of basis images in each of the plurality of layers.

In some embodiments, capturing the images of the plurality of basis images includes capturing images produced by point sources or two-dimensional (2D) pixels that are positioned at the plurality of layers.

In some embodiments, the separations between the plurality of layers are constant or increasing with distance from the fixed pattern aperture.

Some embodiments of the method also include forming a plurality of columns of the transformed sensing matrix with the plurality of measurement vectors associated with the plurality of basis images at the different distances.

Some embodiments of the method also include storing information representative of the transformed sensing matrix. The stored transformed sensing matrix is subsequently used to determine values of voxels that represent a 3D image of a scene based on light received from the scene that passes through the fixed pattern aperture and falls on the sensor array.

In some embodiments, determining the values of the voxels that represent the 3D image comprises generating values of the voxels that represent the 3D image of an arbitrary object as a linear combination of the plurality of basis images in the plurality of layers.

Some embodiments of an apparatus include at least one processor and at least one memory including computer program code. The at least one memory and the computer program code are configured to, with the at least one processor, cause the apparatus at least to perform generating measurement vectors based on values of signals generated by sensors in a sensor array based on an intensity of light received by the sensors from a scene through a fixed pattern aperture that has a transmittance that is different in different portions of the fixed pattern aperture. The at least one memory and the computer program code are also configured to, with the at least one processor, cause the apparatus to perform determining values of voxels that represent a three-dimensional (3D) image of the scene based on the measurement vectors.

In some embodiments, the at least one memory and the computer program code are configured to, with the at least one processor, cause the apparatus at least to perform capturing a plurality of measurement vectors of basis images in a plurality of layers positioned at different distances from the fixed pattern aperture and generating a transformed sensing matrix associated with the fixed pattern aperture and the sensor array based on the plurality of measurement vectors.

In some embodiments, the at least one memory and the computer program code are configured to, with the at least one processor, cause the apparatus at least to perform generating values of the voxels that represent the 3D image of an arbitrary object as a linear combination of the basis images in the plurality of layers.

In some embodiments, the at least one memory and the computer program code are configured to, with the at least one processor, cause the apparatus at least to perform generating a vector of coefficients that represent weights of the basis images based on an inverse of the transformed sensing matrix or sparsity maximization of a voxel image and recovering a 3D image that represents the arbitrary object based on the vector of coefficients that represent the weights of the basis images.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is an image capture system that includes a camera for capturing images of objects according to some embodiments.

FIG. 2 is an image capture system that includes a camera for capturing images of objects through a structured pinhole aperture according to some embodiments.

FIG. 3 is a block diagram of an imaging system that is used to calibrate a camera that includes a fixed pattern aperture and a sensor array according to some embodiments.

FIG. 4 is a block diagram of an object that intersects a layer in an image space of a camera according to some embodiments.

FIG. 5 is a flow diagram of a method of calibrating a camera that includes a fixed pattern aperture according to some embodiments.

FIG. 6 is a flow diagram of a method of reconstructing a volumetric image of an object using 2D pixel images captured by a camera that includes a fixed pattern aperture according to some embodiments.

FIG. 7 is a block diagram of a first fixed pattern aperture and a second fixed pattern aperture according to some embodiments.

FIG. 8 is a block diagram of a three-dimensional (3D) fixed pattern aperture, according to some embodiments.

### DETAILED DESCRIPTION

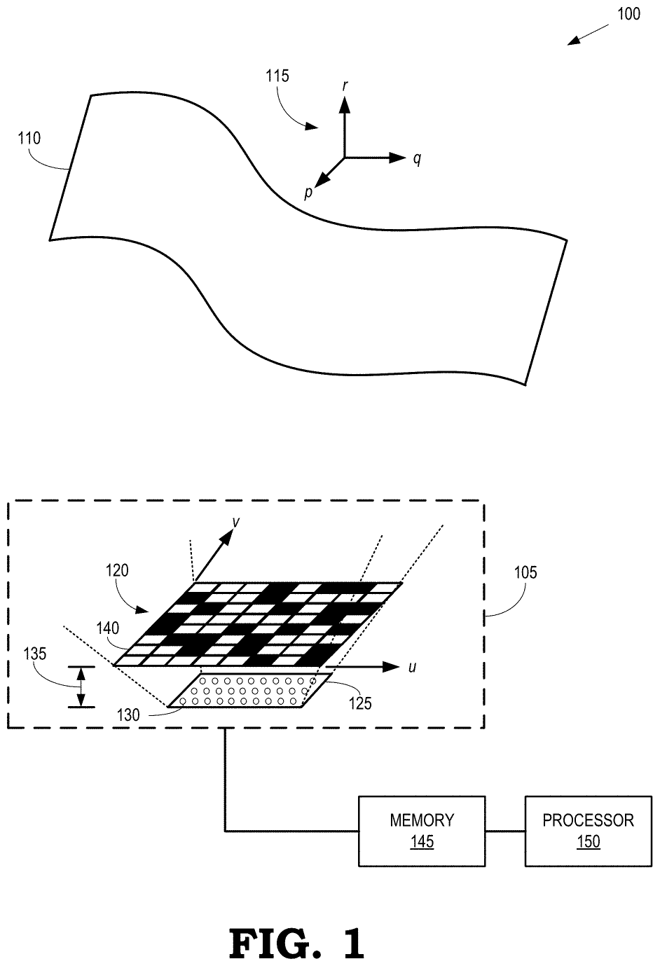

FIGS. 1-8 disclose embodiments of a camera that directly captures values of voxels that represent a 3D image using a fixed pattern aperture that is positioned in front of a sensor array. The fixed pattern aperture includes a pattern of varying transmittance that has different values at different locations across the pattern. Some embodiments of the fixed pattern include a pattern that is substantially transparent (i.e., exhibits relatively high transmittance) in some locations and substantially opaque (i.e., exhibits relatively low transmittance) in other locations. As used herein, the term “substantially” is used to indicate that transparent locations are transparent within a predetermined tolerance, although a small amount of light at some frequencies may be reflected or absorbed by the fixed pattern aperture, and opaque locations are opaque within a predetermined tolerance, although a small amount of light at some frequencies may pass through the opaque locations in the fixed pattern aperture. The pattern can be a randomly selected pattern, an orderly selected pattern (e.g. Hadamard matrix), a naturally occurring pattern (e.g. porous materials), or any other pattern of variable transmittance. Light from the voxels that represents an object passes through the transparent portions of the pattern and falls on the sensor array. The sensors in the sensor array generate signals based on the intensity of the light that falls on the sensors. The set of values recorded by the sensors in the sensor array forms a vector of measurements that includes volumetric information for the voxels because each voxel projects a different image of the pattern onto the sensor array. The values of the voxels can therefore be recovered from the measurement vector if a sensing matrix that represents the relationship between the voxels and the measurement vector is known. However, the actual sensing matrix cannot always be determined, e.g., if the pattern of transmittance is not known.

Instead of calculating the actual sensing matrix for an imaging device that includes a fixed pattern aperture and a sensor array, a transformed version of the sensing matrix is determined (i.e., the transformed sensing matrix is calibrated) by recording a series of measurement vectors for known objects, which are referred to herein as basis images. In some embodiments, the basis images are point sources or 2D pixels that are positioned at varying distances from the imaging device during the calibration process. The basis images at a particular distance form a layer of basis images. To generate the transformed sensing matrix, the imaging device captures an image of each basis image in a layer that is one of a sequence of layers at increasing distances from the imaging device. Separations between successive layers can be constant, can increase as the distance from the imaging device increases, or can vary according to some other algorithm. For each basis image in each layer, intensities recorded by the sensors in the sensor array are vectorized and the vectorized intensities form a column of the transformed sensing matrix that corresponds to the basis image and the layer. The process is repeated for all the basis images over the sequence of layers to form the complete transformed sensing matrix. The pattern used to form the fixed pattern aperture does not need to be known to calibrate the transformed sensing matrix for the imaging device. The calibration is valid as long as the relative position and orientation of the fixed pattern aperture and the sensor array remains fixed.

A volumetric image of an arbitrary object is represented as a linear combination of the basis images in different layers. Light from the arbitrary object passes through the fixed pattern aperture and falls on the sensors in the sensor array. The imaging device captures a measurement vector that includes intensities measured by the sensors in the sensor array when exposed to light from the arbitrary object. If the number of measurements is larger than the number of voxels, a 3D image that represents the arbitrary object is recovered by multiplying each basis image by the corresponding weight, summing the weighted basis images for each layer, and forming a union of the weighted and summed basis images over the different layers used in the calibration process. The measurement vector is multiplied by the inverse of the calibrated sensing matrix to generate a vector of coefficients that represent weights of the basis images that were used to calibrate the imaging device. If the number of measurements is smaller than the number of voxels, the 3D image is recovered using algorithms such as sparsity maximization because the number of unknowns (i.e., the values of the voxels) is smaller than the number of measurements. Additional rendering is performed in some embodiments to finalize the 3D image.

FIG. 1 is an image capture system 100 that includes a camera 105 for capturing images of objects according to some embodiments. In the illustrated embodiment, the camera 105 captures a volumetric or 3D image of an object 110 in a scene. Locations, positions, and orientations of portions of the object 110 are measured relative to a 3D coordinate system 115 and the coordinates are referred to herein as p,q,r. The camera 105 includes a fixed pattern aperture 120 and a sensor array 125 that includes sensors 130. Only one sensor 130 is indicated by a reference numeral in the interest of clarity. The fixed pattern aperture 120 and the sensor array 125 are separated by a distance 135, which remains fixed after the camera 105 has been calibrated, as discussed herein.

The fixed pattern aperture 120 is formed of a pattern that has a transmittance that varies across the pattern so that the amount of light transmitted by the fixed pattern aperture 120 is different depending on the incident location of the light on the fixed pattern aperture 120. Thus, the fixed pattern aperture 120 selectively blocks light so that the sensors 130 in the sensor array 125 perform independent measurements of an image of the object 110. Some embodiments of the fixed pattern aperture 120 are formed of elements 140 (only one indicated by a reference numeral in the interest of clarity) that include a first portion of elements that are transparent (i.e., relatively high transmittance as indicated by the white filled squares) and a second portion of elements that are opaque (i.e., relatively low transmittance as indicated by the black filled squares). The fixed pattern aperture 120 is 3D-structured and has a thickness of δ. Some embodiments of the fixed pattern aperture 120 are fabricated using a high porosity material or an approximately two-dimensional (2D) thin-film of high resolution with a small thickness δ. The pattern represented by the first and second portion of the elements of the fixed pattern aperture 120 is stationary and does not need to be known in order to capture volumetric images, as discussed herein. The pattern is a randomly selected pattern or an orderly selected pattern. Furthermore, some embodiments of the fixed pattern aperture 120 are formed using a naturally occurring pattern of transmittance in a high porosity material that has a transmittance that has different values at different locations.

The sensor array 125 includes a high density of sensors 130, which can be implemented as charge coupled device (CCD) sensors, complementary metal-oxide semiconductor (CMOS) sensors, and the like. The sensors 130 generate signals based on light received from the object 110 (or other scene) that passes through the fixed pattern aperture 120 before falling on the sensor array 125. The independent signals (yₘ) generated by the sensors 125 based on the received light are represented as:

$${y}_{m} = \int {\int }_{R} \int f ( u ( p , q , r ; m ) , v ( p , q , r ; m ) , \\ θ ( p , q , r ; m ) , ϕ ( p , q , r ; m ) ) I ( p , q , r ) dpdqdr$$

$$m = 1 , … , M$$

where ƒ(u,v,θ,φ) represents a general pattern of transmittance at position (u,v) in the fixed pattern aperture 120 and incidence angle (θ,φ) relative to the uv-plane at the fixed pattern aperture 120. The function ƒ(u,v,θ,φ) therefore represents a transmittance function as seen by the m-th sensor 130 due to a point source at the position (p,q,r). The intensity I(p,q,r) is a volumetric image whose non-zero components appear only at a surface of an opaque object 110 that is visible to the sensors 130. The number of sensors 130 is M in the illustrated embodiment and R is the 3D space of the object 110.

The imaging system 100 also includes a memory 145 to store information that represents signals acquired by the sensors 130 and the sensor array 125. A processor 150 performs operations on the information stored in the memory 145, such as calibration of the camera 105, determination of weights of basis images that represent the object 110, and reconstruction of a 3D or volumetric image of the object 110, as discussed herein. Results of the operations performed by the processor 150 are stored in the memory 145. The memory 145 and the processor 150 can be implemented internal to the camera 105 or external to the camera 105 or a combination thereof.

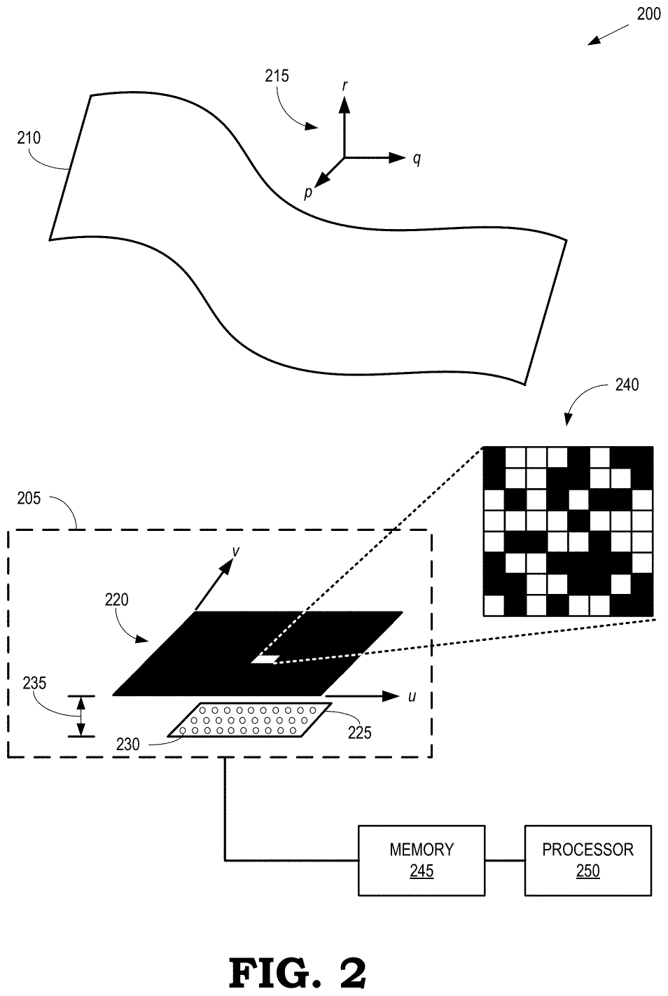

FIG. 2 is an image capture system 200 that includes a camera 205 for capturing images of objects through a structured pinhole aperture according to some embodiments. In the illustrated embodiment, the camera 205 captures a volumetric or 3D image of an object 210 in a scene. Locations, positions, and orientations of portions of the object 210 are measured relative to a 3D coordinate system 215 and the coordinates are referred to herein as p,q,r. The camera 205 includes a fixed pattern aperture 220 and a sensor array 225 that includes sensors 230. Only one sensor 230 is indicated by a reference numeral in the interest of clarity. The fixed pattern aperture 220 and the sensor array 225 are separated by a distance 235, which remains fixed after the camera 205 as been calibrated, as discussed herein.

The fixed pattern aperture 220 includes a structured pinhole aperture 240. As used herein, the term “structured pinhole” indicates that the structured pinhole aperture 240 has a fixed pattern on the hole aperture. Due to the small size of aperture 240, the signal-to-noise ratio is very low, which can require a longer measurement time, but the fixed pattern aperture 220 doesn't suffer from the problem of object partial occlusion. For example, a point on the object 210 is considered partially occluded if a point on the object 210 is seen from some of sensors 230 but it is not seen from other sensors 230 by the object 210 (or other objects in the scene). Light received from the partially occluded point can be measured through an unknowingly altered pattern representation from what was calibrated, which may result in inaccurate reconstruction for the point. The potential existence of a fully occluded point can be ignored because it doesn't affect any measurements.

The imaging system 200 also includes a memory 245 to store information that represents signals acquired by the sensors 230 and the sensor array 225. A processor 250 performs operations on the information stored in the memory 245, such as calibration of the camera 205, determination of weights of basis images that represent the object 210, and reconstruction of a 3D or volumetric image of the object 210, as discussed herein. Results of the operations performed by the processor 250 are stored in the memory 245. The memory 245 and the processor 250 can be implemented internal to the camera 205 or external to the camera 205 or a combination thereof.

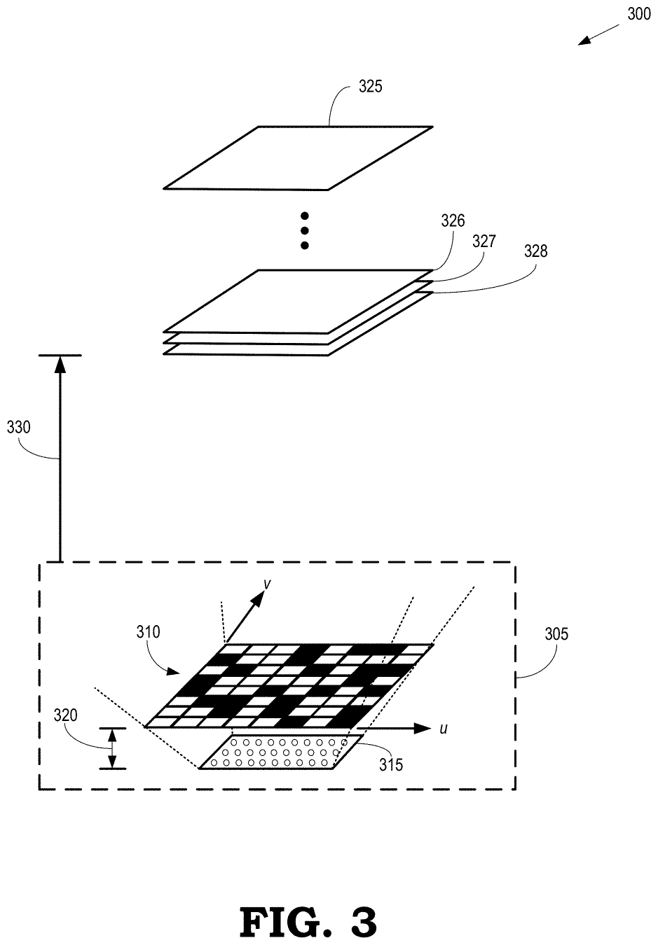

FIG. 3 is a block diagram of an imaging system 300 that is used to calibrate a camera 305 that includes a fixed pattern aperture 310 and a sensor array 315 according to some embodiments. The camera 305 is used to implement some embodiments of the camera 105 shown in FIG. 1 or the camera 205 shown in FIG. 2. The fixed pattern aperture 310 is offset from the sensor array 315 by a distance 320, which remains fixed during and after the calibration process. The fixed pattern aperture 310 includes a pattern that has a variable transmittance, which can be formed using a randomly selected pattern of elements having relatively high and relatively low transmittance, an orderly selected pattern of elements having different transmittances, or naturally occurring patterns of transmittance. The pattern of the fixed pattern aperture 310 is associated with a transmittance function and a corresponding sensing matrix. However, neither the transmittance function nor the corresponding sensing matrix needs to be known in order to calibrate the camera 305 and capture volumetric images using the camera 305. For example, the pattern, transmittance function, and sensing matrix are likely to be difficult or impossible to determine if the pattern in the fixed pattern aperture 310 is formed using a naturally occurring process. However, the pattern remains fixed once the calibration process has been performed. If either the distance 320 or the pattern in the fixed pattern aperture 310 changes, the calibration process is performed again to recalibrate the camera 305.

The image space that includes objects for imaging by the camera 305 is sliced into layers at different distances from the camera 305. In different configurations, the layers are separated by distances that are equal to each other, distances that increase in scale with increasing distance from the camera 305, or other distributions of separations between the layers. In the illustrated embodiment, the image space is sliced into layers 325, 326, 327, 328 (referred to collectively herein as “the layers 325-328”) that are at different distances from the camera 305. For example, the layer 328 is at a distance 330 from the camera 305 and the layers 325-327 are positioned at increasing distances from the camera 305.

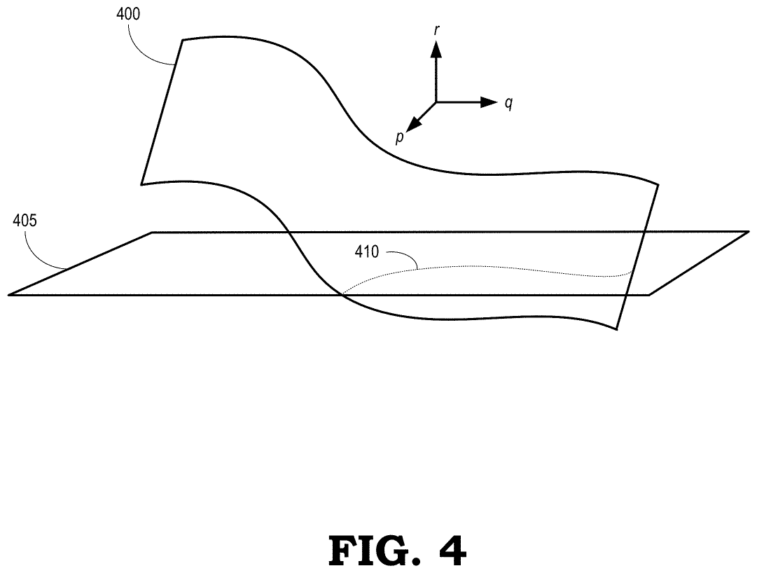

FIG. 4 is a block diagram of an object 400 that intersects a layer 405 in an image space of a camera according to some embodiments. The layer 405 represents some embodiments of one of the layers 325-328 shown in FIG. 3. The points of intersection between the object 300 and the layer 405 are indicated by the dotted line 410. If the 3D surface of the object 400 is represented as I(p,q,r) and the points of intersection 410 with the l-th layer 405 (which correspond to the non-zero components of the image of the object 400 in the layer 405) are represented as Îₗ(p,q), then the image of the object 400 is represented as the union of the points of intersection with the L layers in the image space:

$$I ( p , q , r ) \approx {{⋃}^{L}}_{l = 1} {\tilde{I}}_{l} ( p , q )$$

Referring to FIG. 3 and FIG. 4, calibration of the camera 305 is performed using a display that is positioned at distances corresponding to the layers 325-328 during successive time intervals. The display presents different image patterns that are captured by the camera 305. The image patterns at each layer 325-328 are referred to as basis images. For example, the display positioned in the layer 325 can present a set of basis images during successive time intervals and the camera 305 can capture the set of basis images. The display is then moved successively to the layers 326-328 and the (same or different) set of basis images is presented for captured by the camera 305 by the display at each of the layers 326-328.

An image is decomposed into basis images Bₖ^{l}(p,q), where the basis images in each layer l=1 . . . L are indicated by an index k=1 . . . K. A portion of a volumetric image of an object that intersects with the l-th layer is represented as a “sliced image,” which is a sum of weighted basis images for the l-th layer:

$${\tilde{I}}_{l} ( p , q ) = {\sum }_{k = 1}^{K} {w}_{k}^{l} {B}_{k}^{l} ( p , q )$$

where Bₖ^{l}(p,q) is interpreted as the k-th basis image of the l-th layer that is added to the volumetric image with the weight wₖ^{l}. The complete image is represented as a sum over the sliced images:

$$I ( p , q , r ) \approx {{⋃}^{L}}_{l = 1} {\sum }_{k = 1}^{K} {w}_{k}^{l} {B}_{k}^{l} ( p , q )$$

A noise term ε is added to some representations of the image as follows:

$$I ( p , q , r ) = {{⋃}^{L}}_{l = 1} {\sum }_{k = 1}^{K} {w}_{k}^{l} {B}_{k}^{l} ( p , q ) + ɛ ( p , q , r )$$

The noise includes errors due to incompleteness of the number of basis images and approximation of layered representation.

A transformed sensing matrix is constructed for the camera 305 using the measurements of the set of basis images in the layers 325-328 shown in FIG. 3. The sensing matrix for the camera 305 is constructed without necessarily knowing the transmittance (ƒ) of the fixed pattern aperture 310. The camera 305 performs M measurements simultaneously or concurrently and the m-th measurement is represented as:

$${y}_{m} = {\sum }_{l = 1}^{L} {\sum }_{k = 1}^{K} {w}_{k}^{l} [ \int {\int }_{{R}_{l}} f ( u ( p , q , r ; m ) , v ( p , q , r ; m ) , \\ θ ( p , q , r ; m ) , ϕ ( p , q , r ; m ) ) {B}_{k}^{l} ( p , q ) dp d q ] + \int \int {\int }_{R} f ( u ( p , q , r ; m ) , v ( p , q , r ; m ) , θ ( p , q , r ; m ) , \\ ϕ ( p , q , r ; m ) ) ɛ ( p , q , r ) dpdqdr = {\sum }_{l = 1}^{L} {\sum }_{k = 1}^{K} {w}_{k}^{l} {b}_{k}^{l} + {e}_{m} = {\sum }_{n = 1}^{K L} {A}_{m n} {c}_{n} + {e}_{m}$$

$$n = K ( l - 1 ) + k$$

The measurement vector is represented in matrix form as:

y=Ac+e

where A is the transformed sensing matrix of dimensions M×N and ε is a noise term. The transformed sensing matrix A represents the relationship between the measurement vector y and the weights of basis images c and is determined during the calibration process. Thus, the transmittance (ƒ) of the pattern in the fixed pattern aperture 315 does not need to be known to use the camera 305 to generate volumetric images.

The display that is used to calibrate the camera 305 generates a set of digital images that are displayed as basis images. Some embodiments of the display are an LED monitor or an LCD monitor. The camera 305 measures the basis images that are displayed at the different layers 325-328 and these measurements are used to form the transformed sensing matrix A. In some embodiments, the camera 305 directly acquires the (K(l−1)+k)-th column of the transformed sensing matrix A by taking an image of Bₖ^{l}(p,q) using the sensor elements in the sensor array 310 and vectorizing the signals received from the sensor elements. Thus, the camera 305 generates the transformed sensing matrix A without calculating the complicated function of transmittance (ƒ). The calibration of the camera 305 is therefore performed in a relatively short time because the basis images Bₖ^{l}(p,q) are quickly generated on a monitor. The basis images Bₖ^{l}(p,q) are also discrete and digitized images, e.g., the basis images Bₖ^{l}(p,q)≅Bₖ^{l}(i,j), where i,j are discrete point locations. A basis image can be a point source, a Hadamard pattern, a discrete cosine transform (DCT) pattern, and the like.

A volumetric or 3D image of an object such as the object 400 shown in FIG. 4 is recovered from measurements taken by the camera 305. In some embodiments, image recovery is performed by a processor such as the processor 150 shown in FIG. 1, e.g., using image data stored in the memory 145 shown in FIG. 1. If the number of measurements captured by sensors in the sensor array 315 of the camera 305 is larger than the number of voxels that represent the object 400, a vector of coefficients that represent weights of the basis images is found by multiplying the measurement vector by the inverse of the transformed sensing matrix. Then, a 3D image that represents the object 400 is recovered by multiplying each basis image Bₖ^{l}(p,q) by the corresponding weight wₖ^{l}, summing the weighted basis images wₖ^{l}Bₖ^{l}(p,q) for each layer, and forming a union of the weighted and summed basis images over the different layers used in the calibration process. If the number of measurements is smaller than the number of voxels, the 3D image is recovered using algorithms such as sparsity maximization because a unique solution of voxels to the measurements cannot be determined.

A representation of a surface image (e.g., an intersection of the object with a layer) in a 3D space is highly sparse because the non-zero components are found only at the intersection with the surface. In some embodiments, a maximum sparsity technique is therefore used to recover the 3D surface image according to the following optimization:

$$\{ \begin{matrix}\hat{c} = min {‖ Bc ‖}_{1} s . t . {‖ y - Ac ‖}_{2} \leq η \\ {\tilde{I}}_{l} ( p , q ) = {{⋃}^{L}}_{l = 1} {\sum }_{k = 1}^{K} {\hat{c}}_{K ( l - 1 ) + k} {B}_{k}^{l} ( p , q )\end{matrix} \\ where \text{:} \\ B = ( \begin{matrix}{B}_{1} & O & … & O \\ O & {B}_{2} & ⋱ & ⋮ \\ ⋮ & ⋱ & ⋱ & O \\ O & … & O & {B}_{L}\end{matrix} ) \\ and \\ {B}_{l} = ( v e c ( {B}_{1}^{l} ( p , q ) ) … vec ( {B}_{K}^{l} ( p , q ) ) )$$

However, in other embodiments, other optimizations are applied to recover the 3D image based on the measurements acquired by the camera 305.

Some embodiments of the sensing matrix A have dimensions of M×M, where M=4000. In that case, the sensing matrix A includes 1.6×10⁷ entries. The image space R is subdivided into 64 layers at 500×500 resolution (e.g., 64×500×500) or 256 layers at 250×250 resolution (e.g., 256×250×250). Increasing the number of sensor elements or the compression ratio N/M leads to higher resolution in the 3D space.

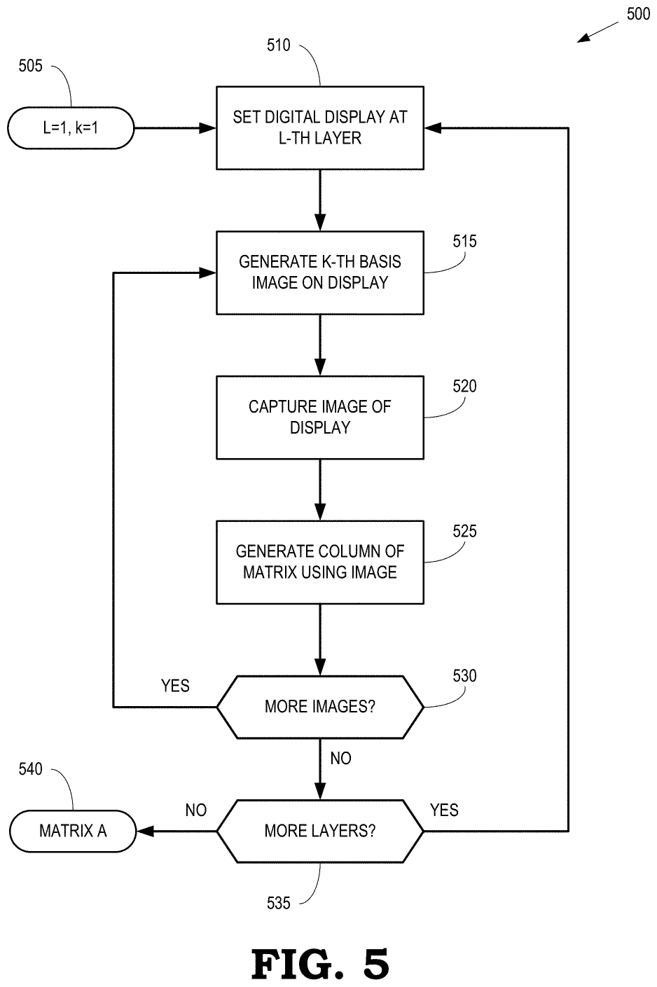

FIG. 5 is a flow diagram of a method 500 of calibrating a camera that includes a fixed pattern aperture according to some embodiments. The method 500 is used to calibrate some embodiments of the camera 105 shown in FIG. 1, the camera 205 shown in FIG. 2, and the camera 305 shown in FIG. 3. As discussed above, the image space is divided into layers at different depths and a display is positioned at the different layers during the calibration process. The display generates a set of basis images at each layer and the basis images are captured by the camera.

At block 505, indices of the layer and the basis images within the layer are initialized to values of l=1 and k=1, respectively.

At block 510, the digital display is positioned at the layer indicated by the corresponding index, l. At block 515, the digital display generates a basis image associated with the current value of the index k. The image is displayed for a predetermined time interval to allow the camera to capture the image. At block 520, the camera captures the image of the display using a sensor array that includes a plurality of sensors such as the sensors 130 shown in FIG. 1. At block 525, a processor (such as the processor 150 shown in FIG. 1) generates a column of a sensing matrix by vectorizing the signals representative of the image provided by the sensors in the sensor array.

At decision block 530, the processor determines whether there are more basis images left to display at the current layer. If so, the method 500 flows to block 515 and the display generates the next basis image for presentation to the camera. If not, the method 500 flows to decision block 535. At decision block 535, the processor determines whether there are more layers left at which to position the display. If so, the method 500 flows to block 510 and the digital display is positioned at the next layer. If not, the method 500 is complete and the processor outputs or stores the sensing matrix A at block 450.

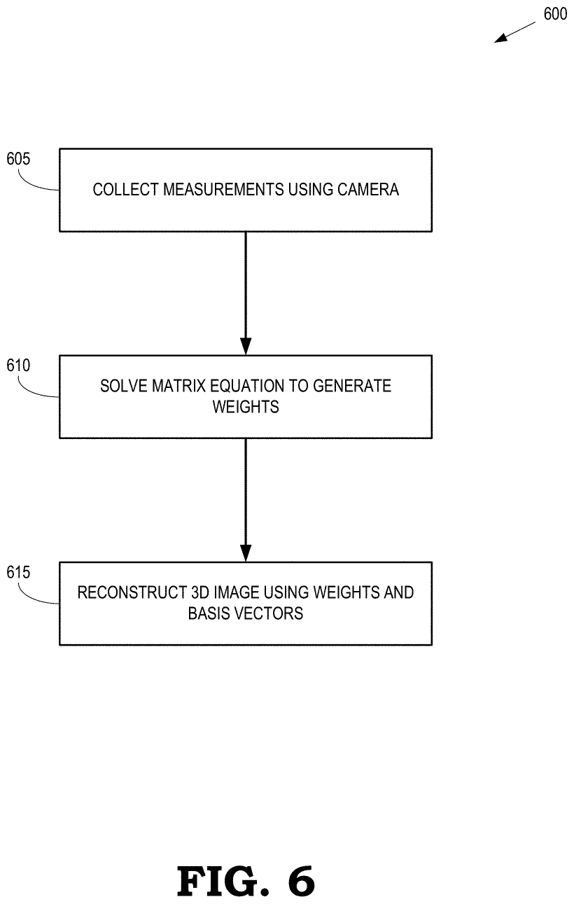

FIG. 6 is a flow diagram of a method 600 of reconstructing a 3D or volumetric image of an object using images captured by a camera that includes a fixed pattern aperture according to some embodiments. The method 600 is implemented in some embodiments of the camera 105 shown in FIG. 1, the camera 205 shown in FIG. 2, and the camera 305 shown in FIG. 3. As discussed herein, the camera has been calibrated to determine a transformed sensing matrix based on a set of basis images that are used to calibrate the camera, e.g., according to the method 500 shown in FIG. 5.

At block 605, the camera collects one or more 2D pixel images of an object as measurements using light received from the object via a fixed pattern aperture such as the fixed pattern aperture 120 shown in FIG. 1, the structured pinhole aperture 240 shown in FIG. 2, and the fixed pattern aperture 310 shown in FIG. 3. The received light falls on a set of sensors and a sensor array such as the sensor array 125 shown in FIG. 1, the sensor array 225 shown in FIG. 2, and the sensor array 315 shown in FIG. 3. Each sensor generates a signal representative of an independent measurement of the intensity of light from the object received via the fixed pattern aperture.

At block 610, a matrix equation that relates the measurements and the sensing matrix to weights associated with the basis images is solved to generate weights of the basis images that are used to represent the volumetric image of the object. In some embodiments, the matrix equation is solved using a maximum sparsity technique that is implemented in a processor such as the processor 150 shown in FIG. 1. The weights generated by the maximum sparsity technique are stored in a memory such as the memory 145 shown in FIG. 1. At block 615, the 3D or volumetric image is reconstructed using the weights and basis factors that are generated using the basis images, as discussed herein.

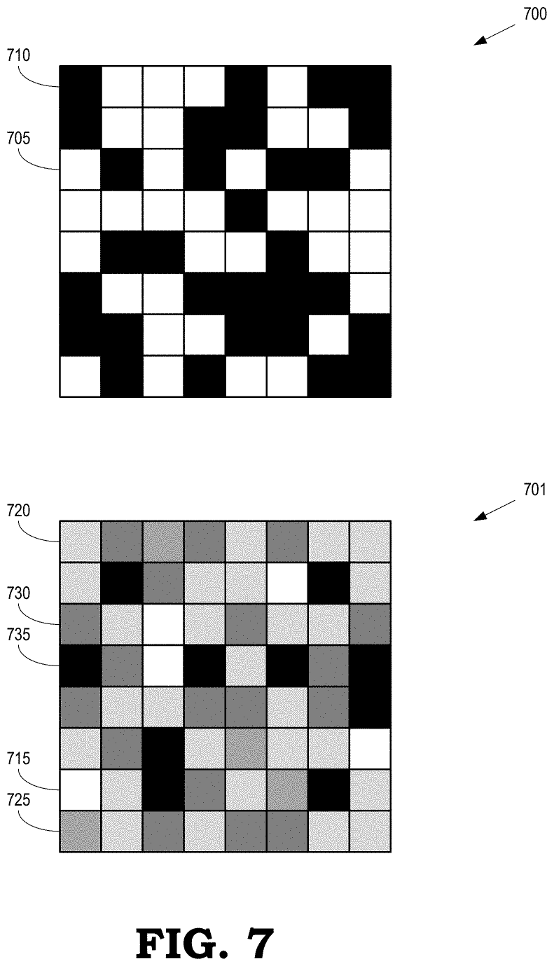

FIG. 7 is a block diagram of a first fixed pattern aperture 700 and a second fixed pattern aperture 701 according to some embodiments. The fixed pattern apertures 700, 701 are used to implement some embodiments of the fixed pattern aperture 120 shown in FIG. 1, the structured pinhole aperture 240 shown in FIG. 2, and the fixed pattern aperture 310 in FIG. 3. The first fixed pattern aperture 700 includes a first portion of elements 705 (only one indicated by reference numeral in FIG. 7 in the interest of clarity) that are substantially transparent and a second portion of elements 710 (only one indicated by reference numeral in FIG. 7 in the interest of clarity) that are substantially opaque. The second fixed pattern aperture 701 includes elements that exhibit a range of transmittances, which are indicated by the grayscale values of the different elements. In the illustrated embodiment, the transmittance ranges from a relatively high value in the element 715 to progressively lower values of the transmittances in the elements 720, 725, 730, 735, respectively, as indicated by the progressively darker grayscale values, i.e., darker grayscale values represent lower transmittances. Although the grayscale values and corresponding transmittances of the elements 715, 720, 725, 730, 735 are illustrated as discrete values in FIG. 7, some embodiments of the second fixed pattern aperture 701 include elements that have transmittances that very continuously from low values to high values. Furthermore, some embodiments of the fixed pattern aperture 701 represent a naturally occurring pattern that has a transmittance that varies across the surface of the fixed pattern aperture in a manner that is not necessarily known.

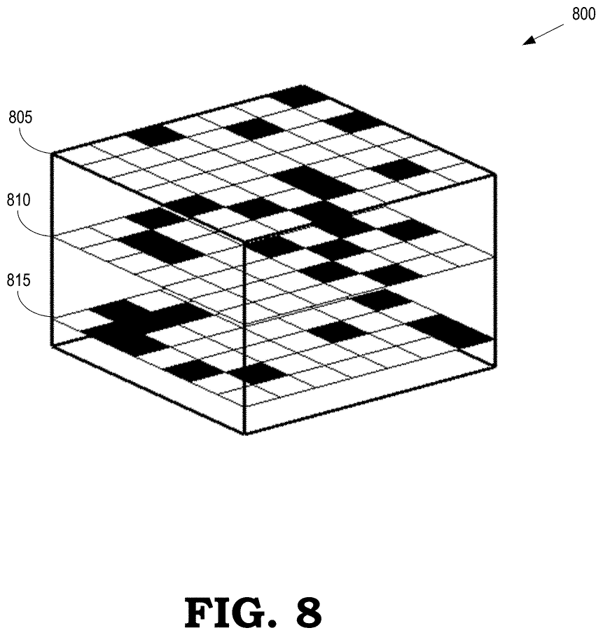

FIG. 8 is a block diagram of a three-dimensional (3D) fixed pattern aperture 800 according to some embodiments. The 3D fixed pattern aperture 800 is used to implement some embodiments of the fixed pattern aperture 120 shown in FIG. 1, the structured pinhole aperture 240 shown in FIG. 2, and the fixed pattern aperture 310 in FIG. 3. The 3D fixed pattern aperture 800 includes three layers 805, 810, 815 that each include a different pattern of transmittances. The patterns in the layers of 805, 810, 815 can be formed in accordance with any of the patterns disclosed herein. Although three layers 805, 810, 815 are shown in FIG. 8, some embodiments of the 3D fixed pattern aperture 800 include more or fewer layers that may have the same or different patterns. Furthermore, some embodiments of the 3D fixed pattern aperture 800 represent a naturally occurring pattern that has a transmittance that varies across the volume of the 3D fixed pattern aperture 800 in a manner that is not necessarily known.

Some embodiments of the techniques disclosed herein are implemented in a lensless camera or a flat camera for a smart phone or display panel because the stationary fixed pattern aperture can be deployed very close to the sensor with a small form factor. Some embodiments of the camera disclosed herein can apply the 3D imaging capability to depth estimation or 3D object recognition such as face recognition, hand gesture recognition, human behavior recognition, and the like. Moreover, some embodiments of the camera disclosed herein capture the 3D images on a very short time scale and are therefore able to perform 3D video capture of fast-moving objects.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

As used herein, the term “circuitry” may refer to one or more or all of the following:
a) hardware-only circuit implementations (such as implementations and only analog and/or digital circuitry) and
b) combinations of hardware circuits and software, such as (as applicable):
   i. a combination of analog and/or digital hardware circuit(s) with software/firmware and
   ii. any portions of a hardware processor(s) with software (including digital signal processor(s), software, and memory(ies) that work together to cause an apparatus, such as a mobile phone or server, to perform various functions) and
c) hardware circuit(s) and/or processor(s), such as a microprocessor(s) or a portion of a microprocessor(s), that requires software (e.g., firmware) for operation, but the software may not be present when it is not needed for operation.
   This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A camera comprising:
a fixed pattern aperture having a three-dimensional (3D) pattern of transmittance, wherein the transmittance is different in different portions of the fixed pattern aperture; and
a sensor array comprising a plurality of sensors that generate signals based on an intensity of light received by the sensors through the fixed pattern aperture.

2. The camera of claim 1, wherein the 3D pattern of transmittance is unknown.

3. The camera of claim 1, wherein the 3D pattern of transmittance is determined by a randomly selected pattern, an orderly selected pattern, or a naturally occurring pattern.

4. The camera of claim 1, wherein the fixed pattern aperture comprises a structured pinhole aperture.

5. The camera of claim 1, wherein the sensor array is configured to capture a measurement vector of intensities of light from an arbitrary object that passes through the fixed pattern aperture.

6. The camera of claim 1, wherein the sensor array is configured to capture a plurality of measurement vectors by capturing images of a plurality of basis images in each of a plurality of layers at different distances from the camera.

7. The camera of claim 6, wherein separations between the plurality of layers are constant or increasing with distance from the fixed pattern aperture.

8. An apparatus comprising:
at least one processor; and
at least one memory including computer program code, the at least one memory and the computer program code configured to, with the at least one processor, cause the apparatus at least to perform:
receiving signals from a device comprising a fixed pattern aperture having a three-dimensional (3D) pattern of transmittance and a sensor array comprising a plurality of sensors that generate signals based on an intensity of light received by the sensors through the fixed pattern aperture;
generating measurement vectors based on the signals generated by the sensors in the sensor array when exposed to a scene; and
determining values of voxels that represent a 3D image of the scene based on the measurement vectors.

9. The apparatus of claim 8, wherein the at least one memory and the computer program code are further configured to, with the at least one processor, cause the apparatus at least to further perform:
generating the values of the voxels that represent the 3D image of an arbitrary object by forming a linear combination of a plurality of basis images associated with a plurality of layers positioned at different distances from the fixed pattern aperture.

10. The apparatus of claim 9, wherein the at least one memory and the computer program code are further configured to, with the at least one processor, cause the apparatus at least to further perform:
generating a vector of coefficients that represent weights of the basis images based on an inverse of a transformed sensing matrix associated with the fixed pattern aperture or sparsity maximization of a voxel image.

11. The apparatus of claim 10, wherein the at least one memory and the computer program code are further configured to, with the at least one processor, cause the apparatus at least to further perform recovering a 3D image that represents the arbitrary object based on the vector of coefficients that represent the weights of the basis images.

12. The apparatus of claim 10, wherein the at least one memory and the computer program code are further configured to, with the at least one processor, cause the apparatus at least to further perform:
generating the transformed sensing matrix based on a plurality of measurement vectors of basis images in the plurality of layers positioned at different distances from the fixed pattern aperture.

13. The apparatus of claim 12, wherein the sensor array is configured to capture a plurality of measurement vectors by capturing images of a plurality of basis images in each of the plurality of layers.

14. The apparatus of claim 13, wherein separations between the plurality of layers are constant or increasing with distance from the fixed pattern aperture.

15. The apparatus of claim 13, wherein the at least one memory and the computer program code are further configured to, with the at least one processor to cause the apparatus at least to further perform forming a plurality of columns of the transformed sensing matrix with the plurality of measurement vectors associated with the plurality of basis images at the different distances.

16. A method comprising:
receiving, using a sensor array that includes a plurality of sensors, light from a plurality of layers through a fixed pattern aperture having a three-dimensional (3D) pattern of transmittance that is different in different portions of the fixed pattern aperture, wherein the layers are positioned at different distances from the fixed pattern aperture;
generating a plurality of measurement vectors of basis images based on the light received from the plurality of layers through the fixed pattern aperture; and
generating a transformed sensing matrix associated with the fixed pattern aperture and the sensor array based on the plurality of measurement vectors.

17. The method of claim 16, wherein capturing the plurality of measurement vectors comprises capturing images of a plurality of basis images in each of the plurality of layers.

18. The method of claim 17, wherein capturing the images of the plurality of basis images comprises capturing images produced by point sources or two-dimensional (2D) pixels that are positioned at the plurality of layers.

19. The method of claim 18, wherein separations between the plurality of layers are constant or increasing with distance from the fixed pattern aperture.

20. The method of claim 19, further comprising:
forming a plurality of columns of the transformed sensing matrix with the plurality of measurement vectors associated with the plurality of basis images at the different distances.

21. The method of claim 20, further comprising:
storing information representative of the transformed sensing matrix, wherein the stored transformed sensing matrix is subsequently used to determine values of voxels that represent a 3D image of a scene based on light received from the scene that passes through the fixed pattern aperture and falls on the sensor array.

22. The method of claim 21, wherein determining the values of the voxels that represent the 3D image comprises generating values of the voxels that represent the 3D image of an arbitrary object as a linear combination of the plurality of basis images in the plurality of layers.
